(19) United States
(12) Patent Application Publication
(10) Pub. No.: US 2020/0198726 A1
(43) Pub. Date: Jun. 25, 2020

(54) SELF POWER GENERATION-TYPE ELECTRIC BIKE

(71) Applicants: Deok Sam BIN, Jeollabuk-do (KR); Gyo Hun VIN, Jeollabuk-do (KR)

(72) Inventor: Deok Sam BIN, Jeollabuk-do (KR)

(21) Appl. No.: 16/609,004

(22) PCT Filed: Sep. 20, 2018
(86) PCT No.: PCT/KR2018/011147

§ 371 Date: Oct. 28, 2019

(30) Foreign Application Priority Data
Sep. 20, 2017 (KR) 10-2017-0121099

(51) Int. Cl. B62M 6/55; B62K 3/02; B62M 6/90; B62J 1/02

(52) U.S. Cl. CPC B62M 6/55; B62J 1/02; B62M 6/90; B62K 3/02

(57) ABSTRACT

The present invention relates to a self-power generation-type electric bike, and particularly, to a self-power generation-type electric bike which can be applied to an electric bike (an electric bicycle, an electric motorcycle, an electric kick scooter, etc.) to generate air during travel, and use the air to produce electricity and travel for long periods of time without being charged.

### TECHNICAL FIELD

The present invention relates to a self-power generation-type electric bike, and particularly, to a self-power generation-type electric bike which can be applied to an electric bike (an electric bicycle, an electric motorcycle, an electric kick scooter, etc.) to generate air during travel, and use the air to produce electricity and travel for long periods of time without being charged.

### BACKGROUND ART

In order to prepare for the depletion of fossil fuels, much efforts are globally being made to develop a transportation device that operates by an alternative fuel.

In particular, in order to increase the use of bicycles that may reduce the use of vehicles, efforts are being made to develop electric bicycles or electric vehicles that can comfortably travel over long distances, in addition to construction and expansion of a road for bicycles exclusive use.

In addition, in order to solve the charging problem of the electric bicycles, which have been spotlighted as a modern transportation device when a storage battery (secondary battery), which is an alternative energy having little pollution, is used as a power source, a lot of resources have been inputted into the development of a light, thin, simple, and small type storage battery that can be used for a long time, the technology development on a charging method for reducing a charging time, and the expansion of charging facilities for conveniently charging the storage battery anywhere.

However, because a storage battery currently developed and used in the electric bicycles is large and heavy, has a short usable time, is expensive, takes along time for charging, and has insufficient the charging facilities for conveniently charging during traveling, there are many difficulties to promote the distribution of the electric bicycles.

Accordingly, the expansion of the road for bicycle-exclusive use as an infrastructure for allowing bicycles to safely travel, the development of the storage battery that is small, light and usable for a long time, the development of an electric motor having low power consumption, the development of technology on a charging method of easily and conveniently charging the battery in a short time, and the expansion of the charging facilities are necessary in order to promote the distribution of the electric bicycles. In addition, a method of converting an existing pedal-type bicycle into an electric bicycle at low cost is absolutely necessary.

Among the many problems mentioned above, the biggest problems are that a distance, which can be driven by the electric bicycle equipped with an electric motor and a storage battery produced using a current level of technology, is very limited, and a pedal-type bicycle cannot be easily converted to an electric bicycle at low cost.

To solve the above conventional problems Korean Patent Publication No. 10-2010-0069637 or the like discloses the technology that a saddle of a bicycle is installed to be vertically movable to produce electricity by compressed air simultaneously generated upon vertical movements of the saddle and store the electricity in a storage battery, thereby driving the bicycle using the electricity, such that the electric bicycle can be used for a long time without external charging.

However, since the above electric bicycle uses the vertical movements of the saddle, amounts of air generated through the short working distance are small, and thus amounts of electricity production are low.

In addition, the technology cannot be applied to an electric kick scooter that does not have a saddle.

### DESCRIPTION

### Technical Problem

In order to solve the above conventional problems, the present invention provides a self-power generation-type electric bike that can produce a large amount of electricity in a short time by increasing a working distance of an air pump for generating air during traveling of an electric bike, accordingly, travel for a long time without charging, and be applied to the electric kick scooter that does not have a saddle.

### Technical Solution

To this end, the self-power generation-type electric bike of the present invention includes: a main frame; a front wheel mounted to a front of the main frame; a sub-frame disposed at a rear of the main frame; a rear wheel mounted to the sub-frame; a hinge unit configured to couple the sub-frame to the main frame such that one end of the sub-frame is rotatable in a vertical direction at a rear of the main frame; a main air pump having one end connected to the main frame and an opposite end connected to the sub-frame to generate air by a relative movement between the main frame and the sub-frame; an air tank for storing the air generated by the main air pump; a generator for generating electricity by the air jetted from the air tank; and a driving motor for driving the front wheel or the rear wheel by the electricity generated from the generator, wherein the sub-frame is rotated in the vertical direction with respect to the main frame about the hinge unit, the main air pump has the one end hinged to the main frame and the opposite end hinged to the sub-frame at a rear of the hinge unit, and the main air pump generates the air while being compressed or expanded by the relative rotational movement between the main frame and the sub-frame about the hinge unit.

The self-power generation-type electric bike of the present invention may further includes a main elastic member disposed between the main frame and the sub-frame to add an elastic force in opposite directions, wherein the main elastic member generates the elastic force to recover the main frame and the sub-frame to initial positions upon the relative rotational movement between the main frame and sub-frame by an external force.

The opposite end of the main air pump is hinged to the sub-frame at a rear of a center of the rear wheel with respect to the hinge unit.

The main frame has a hollow shape, and the air generated from the main air pump moves to the air tank through an inside of the main frame.

The self-power generation-type electric bike of the present invention may further includes a pedal unit rotatably mounted to the main frame; and a power transmission member for transmitting a rotational driving force generated by the pedal unit to the rear wheel by connecting the pedal unit to the rear wheel, wherein the hinge unit is disposed at an equal position of or in front of a center of the pedal unit.

The self-power generation-type electric bike of the present invention may further includes: a pedal unit rotatably mounted to the main frame; a power transmission member for transmitting a rotational driving force generated by the pedal unit to the rear wheel by connecting the pedal unit to the rear wheel; and a tension adjustment unit mounted to the main frame to adjust a tension of the power transmission member, wherein the hinge unit is located at a rear of the center of the pedal unit, and the tension of the power transmission member is adjusted by the tension adjustment unit upon the relative rotational movement between the main frame and the sub-frame about the hinge unit.

The self-power generation-type electric bike of the present invention may further includes: a power transmission member for transmitting a driving force of the driving motor to the rear wheel by connecting the driving motor to the rear wheel, wherein the hinge portion is disposed in front of the driving motor.

The self-power generation-type electric bike of the present invention may further includes: a saddle mounted to an upper portion of the main frame so as to move in the vertical direction; and a sub-air pump and a sub-elastic member mounted below the saddle, wherein the sub-air pump generates air while being compressed or expanded when the saddle vertically moves with respect to the main frame, the air generated from the sub-air pump is stored in the air tank, and the sub-elastic member elastically supports the saddle upward with respect to the main frame.

The self-power generation-type electric bike of the present invention may further includes: a battery mounted to the main frame and connected to the driving motor to supply power, wherein the electricity generated from the generator is stored in the battery, and the air tank actuates the generator by jetting the air to the generator when internal pressure reaches a predetermined value or more.

The main air pump may include: a first air pump for generating air when the main frame and the sub-frame are close to each other; and a second air pump for generating air when the main frame and the sub-frame move away from each other;

### Advantageous Effects

According to the self-power generation-type electric bike of the present invention as described above, advantageous effects are as follows.

According to the present invention, since the main frame and the sub-frame that form a skeleton of the electric bike (such as an electric bicycle, an electric motorcycle, and an electric kick scooter) are hinged to each other, and the other end of the main air pump connected to the sub-frame is located at a rear of the hinge unit, the main air pump may be activated to generate air upon a relative rotational movement between the main frame and the sub-frame about the hinge unit and electricity may be generated by using the air, so that traveling for a long time by the electricity without charging can be implemented.

In particular, according to the present invention, the amount of generated air increases due to the long working distance of the main air pump, so that a large amount of electricity can be efficiently produced in a short time.

In addition, the electric kick scooter without a saddle can be applied, so that the electric kick scooter can be electrically driven by producing electricity while traveling without charging.

### BRIEF DESCRIPTION OF DRAWINGS

FIG. 1 is a view showing a side structure of an electric bike according to a first embodiment of the present invention.

FIG. 2 is a partial perspective view of a rear side of the electric bike according to a second embodiment of the present invention.

FIG. 3 is a schematic rear view of the electric bike according to a first embodiment of the present invention.

FIG. 4 is a schematic view of the electric bike according to a second embodiment of the present invention.

FIG. 5 is a view showing a side structure of the electric bike to which an external force is applied according to a second embodiment of the present invention.

FIG. 6 is a view showing a side structure of an electric bike according to a second embodiment of the present invention.

FIG. 7 is a view showing a side structure of the electric bike according to a third embodiment of the present invention.

### FIRST EMBODIMENT

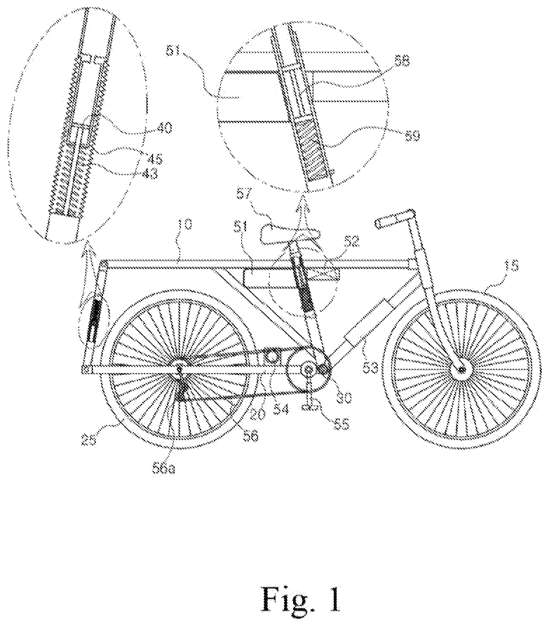

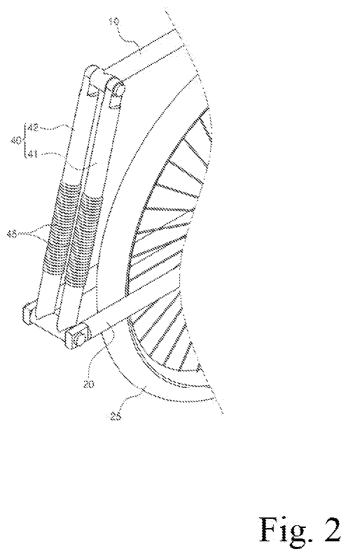

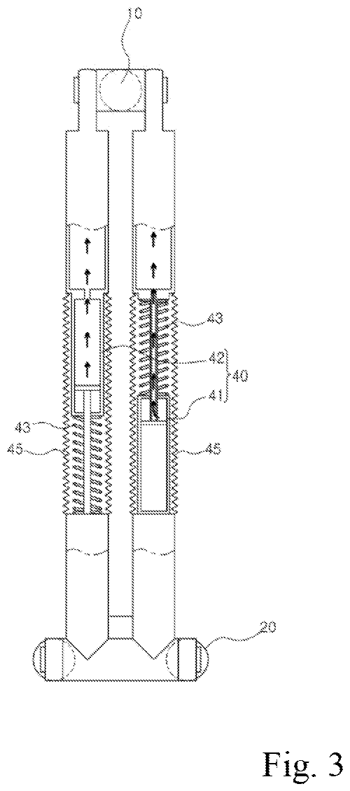

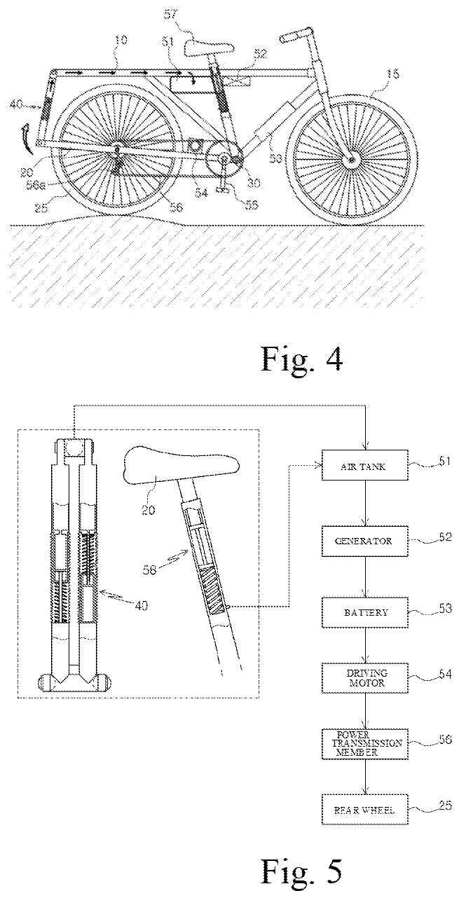

FIG. 1 is a view showing a side structure of an electric bike according to a first embodiment of the present invention. FIG. 2 is a partial perspective view of a rear side of the electric bike according to a second embodiment of the present invention. FIG. 3 is a schematic rear view of the electric bike according to a first embodiment of the present invention. FIG. 4 is a schematic view of the electric bike according to a second embodiment of the present invention. FIG. 5 is a view showing a side structure of the electric bike to which an external force is applied according to a second embodiment of the present invention.

In the first embodiment, the self-power generation-type electric bike of the present invention will be described on the basis of an example of an electric (electrically-driven) bicycle.

The self-power generation-type electric bike of the present invention may include: a main frame 10, front wheel 15, sub-frame 20, rear wheel 25, hinge 30, main air pump 40, main elastic member 43, air tank 51, generator 52, battery 53, and a driving motor 54.

The main frame 10 serves to form an overall skeleton of the electric bicycle, and a handle is mounted in a front of the main frame.

The main frame 10 has an approximately inverted triangular shape, but may be formed in other various shapes.

The front wheel 15 is rotatably mounted to a front lower portion of the main frame 10.

A direction of the front wheel 15 is changed by the handle.

The sub-frame 20 is disposed at a rear of the main frame 10.

The rear wheel 25 is rotatably mounted to the sub-frame 20.

The sub-frame 20 and the main frame 10 are kept in a floating state without making contact with the ground by the front wheel 15 and the rear wheel 25 as described above.

The hinge unit 30 is configured to couple the sub-frame 20 to the main frame 10 such that one end of the sub-frame 20 is rotatable in a vertical direction at a rear of the main frame 10.

In the embodiment, the hinge unit 30 may be located at a rear lower portion of the main frame 10 and one end of the sub-frame 20 may be rotatably coupled to the rear lower portion of the main frame 10.

However, unlike the embodiment, the hinge unit 30 may be rotatably couple to the one end of the sub-frame 20 at various positions at a rear of the main frame 10.

The main air pump 40 has one end connected to the main frame 10 and the other end connected to the sub-frame 20 to generate air by the relative movement between the main frame 10 and the sub-frame 20.

The main air pump 40 is configured to include a cylinder, a piston, and the like, in which one end is hinged to the main frame 10 and the other end is hinged to the sub-frame 20.

In the embodiment, the main air pump 40 has one end arranged at an upper portion is hinged to the main frame 10, and the other end arranged at a lower portion is hinged to the sub-frame 20.

The other end of the main air pump 40 is connected to the sub-frame 20 at a rear of the hinge unit 30.

Accordingly, when the relative rotational movement between the main frame 10 and the sub-frame 20 is applied, in other words, when the sub-frame 20 is rotated with respect to the main frame 10 about the hinge unit 30 due to various external forces, the main air pump 40 generates air while being compressed and/or expanded.

In the embodiment, the other end of the main air pump 40 is hinged to the sub-frame 20 at a rear of the center of the rear wheel 25 with respect to the hinge unit 30.

Accordingly, as shown in FIG. 4, when the sub-frame 20 is rotated about the hinge unit 30, the working distance of the main air pump 40 extends, so that more air may be generated in the main air pump 40.

In particular, when the rear wheel 25 moves in the vertical direction due to an external force by an occupant or a fluctuation of the ground, the sub-frame 20 mounted thereon with the rear wheel 25 is rotated about the hinge unit 30.

At this time, the working distance of the main air pump 40 may extend. The main air pump 40 may be located at a rear of the rear wheel 25, or may be located in a lateral direction of the rear wheel 25.

In addition, as shown in FIGS. 2 and 3, the main air pump 40, may include a first air pump 41 for generating air when the main frame 10 and the sub-frame 20 move away from each other, and a second air pump 42 for generating air when the main frame 10 and the sub-frame 20 is close to each other.

Accordingly, when the sub-frame 20 is close to or moves away from the main frame 10, the air is generated from the first air pump 41 and the second air pump 42, so that air can be more quickly stored in the air tank 51.

The main elastic member 43 is disposed between the main frame 10 and the sub-frame 20, thereby applying an elastic force to the main frame 10 and the sub-frame 20 in opposite directions.

Accordingly, upon the relative rotational movement between the main frame 10 and sub-frame 20 by the external force, the main elastic member 43 generates the elastic force to restore the main frame 10 and the sub-frame 20 to initial positions.

In other words, the main elastic member 43 is compressed or expanded during the rotational movement of the sub-frame 20 about the hinge unit 30.

According to the main elastic member 43 as described above, the main elastic member 43 is also compressed when the sub-frame 20 is rotated upward about the hinge unit 30 by the external force and compresses the main air pump 40.

When the external force is removed or weakened, the sub-frame 20 is rotated downward about the hinge unit 30 by the elastic restoring force of the main elastic member 43, so that the sub-frame 20 is restored to the initial position.

The main elastic member 43 may have the elastic force for at least preventing the main frame 10 and the sub-frame 20 from touching the ground.

The main elastic member 43 may be mounted at various positions while having various shapes.

In the embodiment, the main elastic member 43 is formed of a coil spring and mounted to the main air pump 40.

In the embodiment, a bellows-shaped cover 45 surrounds outer peripheries of the main air pump 40 and the main elastic member 43.

The air tank 51 is mounted to the main frame 10 to store the air generated from the main air pump 40.

The main air pump 40 and the air tank 51 may be connected to each other through a hose or the like.

As in the embodiment, the main frame 10 may have a hollow shape, such that the air generated in the main air pump 40 may be moved and stored to the air tank 51 through an inside of the main frame 10.

A conventional known air tank may be used as the air tank 51, so the detailed description thereof will be omitted.

The generator 52 is mounted to the main frame 10 to generate electricity by the air jetted from the air tank 51.

The generator 52 generates electricity while being rotated by pressure of the air jetted from the air tank 51.

A conventional known generator may be used as the generator 52, so the detailed description thereof will be omitted.

The air tank 51 may jet the air stored therein to the generator 52 when internal pressure reaches a predetermined value or more so as to actuate the generator 52.

The battery 53 is mounted to the main frame 10 to store the electricity generated from the generator 52.

The driving motor 54 drives the front wheel 15 and/or the rear wheel 25 by the electricity generated from the generator 52.

When the battery 53 is present, the driving motor 54 is connected to the battery 53 and uses the electricity stored in the battery 53, thereby driving the front wheels 15 and/or the rear wheels 25.

In addition, when the battery 53 is absent, the driving motor 54 is directly connected to the generator 52 and uses the electricity generated from the generator, thereby driving the front wheels 15 and/or the rear wheels 25.

Meanwhile, since the self-power generation-type electric bike of the present invention is configured to be applied to an electric bicycle, the self-power generation-type electric bike may include a pedal unit 55, a power transmission member 56, a saddle 57, and the like.

The pedal unit 55 is rotatably mounted to a lower portion of the main frame 10.

The power transmission member 56 connects the pedal unit 55 to the rear wheel 25 so that the rotational driving force generated by the pedal unit 55 is transmitted to the rear wheel 25.

The power transmission member 56 may include various components such as a chain and a belt, and may include a gear or the like in some cases.

When the electric bike of the present invention is applied to an electric kick scooter or the like, the driving motor 54 may be directly connected to the rear wheel 25 without the power transmission member 56, or the power transmission member 56 may be composed of a gear transmission or the like to transmit the rotational force of the driving motor 54 to the rear wheel 25.

A tension adjustment member 56a (such as a gear transmission of a general bicycle) for adjusting the tension of the power transmission member 56 may be mounted to the main frame 10 or the like.

In the embodiment, the tension adjustment member 56a may be absent in some cases.

In addition, the hinge unit 30 rotatably coupling the main frame 10 to the sub-frame 20 may be disposed at the same position of or in front of the center of the pedal unit 55.

Accordingly, the rotational driving force of the pedal unit 55 may be smoothly transmitted to the rear wheel 25 without variation of a length of the power transmission member 56 that connects the pedal unit 55 to the rear wheel 25, even when the sub-frame 20 mounted thereon with the rear wheel 25 is rotated in the vertical direction.

In particular, since the hinge unit 30 is disposed at the same position of or in front of the center of the pedal unit 55, the length of the power transmission member 56 is prevented from varying upon the relative rotational movement between the main frame 10 and the sub-frame 20 about the hinge unit 30 even when the tension adjustment member 56a for adjusting the tension of the tension transmission member is absent, so that the power transmission member may be prevented from being loosened and separated, and the rotational driving force of the pedal unit 55 may be accurately transmitted to the rear wheel 25.

The driving motor 54 may transmit motive power to the rear wheel 25 through the power transmission member 56, or may be directly connected to the rear wheel 25 to rotate the rear wheel 25.

The saddle 57 is mounted to an upper portion of the main frame 10 so as to be movable in the vertical direction.

In addition, a sub-air pump 58 and a sub-elastic member 59 are mounted below the saddle 57.

When the saddle 57 is vertically moved with respect to the main frame 10, the sub-air pump 58 is compressed or expanded to generate air, and the air generated from the sub-air pump 58 is stored in the air tank 51.

The sub-elastic member 59 elastically supports the saddle 57 upward with respect to the main frame 10, thereby allowing the saddle 57 to return upward again when the saddle 57 descends.

According to the present invention, when the occupant rides the electric bicycle and the rear wheel 25 vertically moves due to the fluctuation of the ground or the like, the main frame 10 and the sub-frame 20 are relatively rotated around the hinge unit 30 as shown in FIG. 4.

At this time, the main air pump 40 generates air while being compressed, so that the air is stored in the air tank 51.

When the air stored in the air tank 51 reaches predetermined pressure or more, the air is jetted to the generator 52 and actuate the generator 52, thereby producing electricity as shown in FIG. 5.

The electricity produced from the generator 52 is stored in the battery 53 or immediately transmitted to the driving motor 54, thereby electrically driving the rear wheel 25 through the power transmission member 56.

When the occupant applies a force downward to rotate the pedal unit 55, the main frame 10 and the sub-frame 20 are relatively rotated to each other around the hinge unit 30, and thus the electricity may be produced through the above process.

In addition, when the saddle 57 vertically moves, the air is generated and the generated air is jetted to the generator 52, so that the electricity can be generated.

According to the present invention as described above, since the electric bicycle generates electricity and is driven by itself due to vibration caused by a status of the ground or weight of the occupant during traveling of the electric bicycle, a traveling distance of the electric bicycle can extend without charging.

### SECOND EMBODIMENT

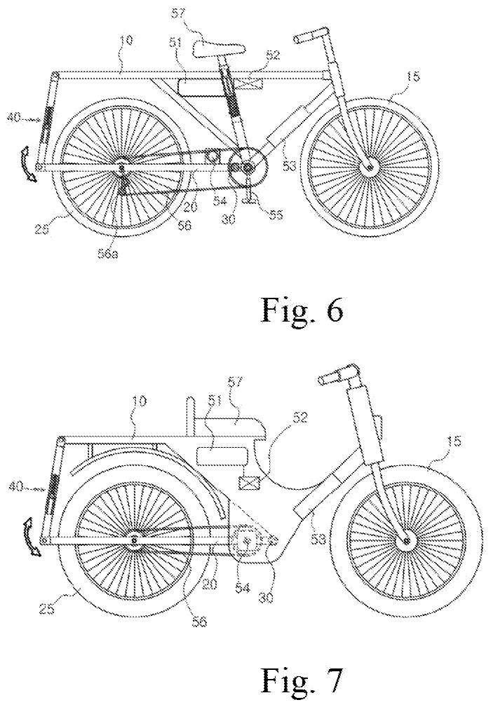

FIG. 6 is a view showing a side structure of an electric bike according to a second embodiment of the present invention.

The second embodiment relates to an electric bicycle as in the first embodiment, and there is a difference in a position of the hinge unit 30 to which the main frame 10 and the sub-frame 20 are coupled.

In the second embodiment, as shown in FIG. 5, the hinge unit 30 is located at a rear of the center of the pedal unit 55.

In the embodiment, unlike the first embodiment, the tension adjustment member 56a, which adjusts the tension of the power transmission member 56 for connecting the pedal unit 55 to the rear wheel 25, is required.

In the embodiment, since the hinge unit 30 is located at a rear of the center of the pedal unit 55, the length of the power transmission member 56 connecting the pedal unit 55 to the rear wheel 25 may be variable when the main frame 10 and the sub-frame 20 are relatively rotated to each other around the hinge unit 30.

At this time, the tension of the power transmission member 56 may be automatically adjusted by the tension adjustment member 56a, so that the power transmission member 56 may smoothly transmit the motive power without being separated from the pedal unit 55 or the rear wheel 25.

Since other features are similar to the features according to the first embodiment, the detailed description thereof will be omitted.

### THIRD EMBODIMENT

FIG. 7 is a view showing a side structure of an electric bike according to a third embodiment of the present invention.

In the third embodiment, the electric bike is applied to an electric motorcycle or an electric kick scooter.

The pedal unit 55 is not provided, compared to the first and second embodiments.

In the embodiment, the power transmission member 56 may connect the driving motor 54 to the rear wheel 25 to transmit the motive power of the driving motor 54 to the rear wheel 25.

The driving motor 54 and the rear wheel 25 may be directly connected to each other through a gear or the like, or may be connected through the power transmission member 56, such as a chain as in the first and second embodiments.

The hinge unit 30 rotatably connecting the main frame 10 to the sub-frame 20 is located in front of the driving motor 54.

Since other features are similar to the features according to the first embodiment, the detailed description thereof will be omitted.

The self-power generation-type electric bike according to the present invention is not limited to the embodiments described above, and various modifications can be made within the allowable scope of the technical idea of the present invention.

### INDUSTRIAL APPLICABILITY

The present invention may be applied to electric bicycles, electric motorcycles, electric kick scooters, and thus has the industrial applicability.

What we claim is:

1. A self-power generation-type electric bike comprising:
a main frame;
a front wheel mounted to a front of the main frame;
a sub-frame disposed at a rear of the main frame;
a rear wheel mounted to the sub-frame;
a hinge unit configured to couple the sub-frame to the main frame such that one end of the sub-frame is rotatable in a vertical direction at a rear of the main frame;
a main air pump having one end connected to the main frame and an opposite end connected to the sub-frame to generate air by a relative movement between the main frame and the sub-frame;
an air tank configured to store the air generated by the main air pump;
a generator configured to generate electricity by the air sprayed from the air tank; and
a driving motor configured to drive the front wheel or the rear wheel by the electricity generated from the generator, wherein
the sub-frame is rotated in the vertical direction with respect to the main frame about the hinge unit, the main air pump has the one end hinged to the main frame and the opposite end hinged to the sub-frame behind the hinge unit, and the main air pump generates the air while being compressed or expanded by a relative rotational movement between the main frame and the sub-frame about the hinge unit.

2. The self-power generation-type electric bike of claim 1, further comprising:
a main elastic member disposed between the main frame and the sub-frame to exert an elastic force in opposite directions, wherein
the main elastic member generates the elastic force to recover the main frame and the sub-frame to initial positions upon the relative rotational movement between the main frame and sub-frame by an external force.

3. The self-power generation-type electric bike of claim 1, wherein the opposite end of the main air pump is hinged to the sub-frame at a rear of a center of the rear wheel with respect to the hinge unit.

4. The self-power generation-type electric bike of claim 1, wherein the main frame has a hollow shape, and the air generated from the main air pump moves to the air tank through an inside of the main frame.

5. The self-power generation-type electric bike of claim 1, further comprising:
a pedal unit rotatably mounted to the main frame; and
a power transmission member for transmitting a rotational driving force generated by the pedal unit to the rear wheel by connecting the pedal unit to the rear wheel, wherein
the hinge unit is disposed at an equal position of or in front of a center of the pedal unit.

6. The self-power generation-type electric bike of claim 1, further comprising:
a pedal unit rotatably mounted to the main frame;
a power transmission member for transmitting a rotational driving force generated by the pedal unit to the rear wheel by connecting the pedal unit to the rear wheel; and
a tension adjustment unit mounted to the main frame to adjust a tension of the power transmission member, wherein
the hinge unit is located at a rear of the center of the pedal unit, and the tension of the power transmission member is adjusted by the tension adjustment unit upon the relative rotational movement between the main frame and the sub-frame about the hinge unit.

7. The self-power generation-type electric bike of claim 1, further comprising:
a power transmission member for transmitting a driving force of the driving motor to the rear wheel by connecting the driving motor to the rear wheel, wherein the hinge portion is disposed in front of the driving motor.

8. The self-power generation-type electric bike of claim 1, further comprising:
a saddle mounted to an upper portion of the main frame so as to move in the vertical direction; and
a sub-air pump and a sub-elastic member mounted below the saddle, wherein
the sub-air pump generates air while being compressed or expanded upon vertical movements of the saddle with respect to the main frame, the air generated from the sub-air pump is stored in the air tank, and the sub-elastic member elastically supports the saddle upward with respect to the main frame.

9. The self-power generation-type electric bike of claim 1, further comprising:
a battery mounted to the main frame and connected to the driving motor to supply power, wherein
the electricity generated from the generator is stored in the battery, and the air tank actuates the generator by jetting the air to the generator when internal pressure reaches a predetermined value or more.

10. The self-power generation-type electric bike of claim 1, wherein the main air pump includes:
a first air pump configured to generate air when the main frame and the sub-frame are close to each other; and
a second air pump configured to generate air when the main frame and the sub-frame move away from each other.
